(19) United States
(12) Patent Application Publication
(10) Pub. No.: US 2020/0079127 A1
(43) Pub. Date: Mar. 12, 2020

(54) PRINTABLE RING ADHESIVES FOR USE IN THE MANUFACTURE OF PORTABLE ELECTRONIC DEVICES

(71) Applicant: Apple Inc., Cupertino, CA (US)

(72) Inventors: Lee E. HOOTON, Ridge, NY (US); Ashley E. FLETCHER, San Francisco, CA (US); Daniel W. JARVIS, Sunnyvale, CA (US); Marwan RAMMAH, San Francisco, CA (US); Richard Hung Minh DINH, Saratoga, CA (US)

(21) Appl. No.: 16/125,381

(22) Filed: Sep. 7, 2018

(51) Int. Cl. B41M 3/00; B41M 1/30; G06F 1/16

(52) U.S. Cl. CPC B41M 3/006; B41M 1/30; G06F 2200/1631; G06F 1/1656; B41P 2200/40; G06F 1/1626

(57) ABSTRACT

This application relates to ring-shaped adhesives for use during the manufacturing of a portable electronic device. The portable electronic device can have a small form factor, such as being a tablet computer or a mobile phone. A printable adhesive is dispensed on a release liner in a shape that conforms with a surface of the portable electronic device. The shape of the printable adhesive follows a path characterized by a continuous closed curve and encloses an area on the release liner without printable adhesive dispensed therein. The width of the printable adhesive along the continuous closed curve can vary to conform to features in one or more surfaces of the portable electronic device. The features can have dimensions of less than one millimeter. The printable adhesive can be can be applied to the release liner by a screen printing process or by dispensing the printable adhesive through a nozzle.

### FIELD

The described embodiments relate generally to manufacturing techniques using adhesives. More particularly, the present embodiments relate to printable adhesives dispensed in shapes conforming to a surface of a portable electronic device.

### BACKGROUND

Adhesives are commonly used in various manufacturing processes. For example, an adhesive can be used to attach a windshield to a chassis of an automobile. The adhesive can also create a seal between the chassis and windshield that prevents or limits the ingress of water into the passenger compartment of the automobile. As another example, an adhesive can be used to fix two plastic components together for children's toys or other consumer goods. Adhesives are desirable for use in a wide variety of applications, including in the manufacture of consumer electronics.

However, there are many technical challenges when utilizing adhesives in a manufacturing setting. For example, adhesives are commonly applied in liquid form, which can be difficult to apply to specific geometry. Other adhesives, such as pressure sensitive adhesives (PSAs), can be applied from a release liner that is subsequently discarded creating waste material. These challenges can be especially difficult with certain geometries such as a ring.

FIG. 1 illustrates a technique for manufacturing an adhesive to be applied to a surface of a portable electronic device, in accordance with the prior art. In various applications, an adhesive can be applied to a surface of a portable electronic device. The surface can include intricate geometry such as a narrow ledge that is formed around the circumference of an internal cavity of a housing of the portable electronic device. The ledge can be, e.g., 50 mil (e.g., 0.05 inches) wide or less around the circumference, and the width of the ledge can vary along the length of the ledge. The dashed lines in FIG. 1 illustrate the shape 110 of the surface.

The adhesive can be provided to the manufacturer from an adhesive vendor on a roll with one or more release liners. The manufacturer can then run the roll of adhesive through a die cut machine to cut out the shape 110 of the adhesive to apply to the surface. However, when the shape 110 conforms to a large closed curve such as a large circle, ellipse, or rectangle, the amount of wasted adhesive can be significant (up to 90% or more wasted material). For example, FIG. 1 illustrates a large interior portion 120 of the adhesive inside the closed shape 110 that will be discarded. It will be appreciated that this discarded material increases the cost of raw materials that must be purchased by the manufacturer.

FIG. 2 illustrates another technique for manufacturing an adhesive to be applied to a surface of a portable electronic device, in accordance with the prior art. The closed shape 110 of the adhesive can be divided into sections 210, and different sections 210 of the shape 110 can be cut from different portions of the roll of adhesive in order to reduce the amount of waste. As depicted in FIG. 2, the shape 110 is divided into four sections 210: a left section 210-1, a right section 210-2, a top section 210-3, and a bottom section 210-4. Each of the sections 210 can be die cut from a small strip of the adhesive roll, thereby reducing the amount of wasted adhesive. However, this technique has certain disadvantages over the first technique illustrated in FIG. 1.

For example, the continuous ring of adhesive can be utilized to provide a seal between two parts, thereby preventing or limiting the ingress of water into a cavity of the device. By dividing the continuous ring into sections, there may be gaps in the ring of adhesive as applied to the surface where the alignment of two adjacent sections is not exact. Furthermore, there may be a gap in the seal where the two sections overlap because the doubled thickness of adhesive at the location of the joint prevents the seal from being formed properly between two complementary parts. In addition, the application of four sections can be more time consuming and more difficult during the assembly process, thereby decreasing a throughput of the assembly line. Consequently, there is a desire to find solutions for preparing adhesives for use in the manufacturing of portable electronic devices that lead to more efficient use of raw materials.

### SUMMARY

This paper describes various embodiments that relate to manufacturing techniques associated with adhesives. More specifically, techniques are disclosed herein that enable printable adhesives to be dispensed on a release liner in a shape that conforms to a surface or surfaces of a portable electronic device. The shape can be referred to as a ring shape, follows a path characterized by a continuous closed curve that forms a ring, circle, ellipse, rectangle, or other non-intersecting regular or irregular curve. The width of the adhesive can vary along the path such that the shape includes one or more features characterized by a transition from a first width at a first point in the path to a second width at a second point in the path. The features can conform to features in the one or more surfaces of the portable electronic device. Such features can be characterized as having small dimensions of, e.g., less than a millimeter to a few millimeters.

In some embodiments, a component is produced that can be shipped to a location of final assembly of a portable electronic device. The component can include a release liner and a printable adhesive dispensed on the release liner in a shape that conforms with a surface of the portable electronic device. The shape of the printable adhesive: follows a path characterized by a continuous closed curve that forms a ring; encloses an area on the release liner without printable adhesive dispensed therein; and has a width that varies along the path.

In some embodiments, the printable adhesive is dispensed on the release liner using a screen printing process. A mesh or screen can be provided with a stencil formed thereon such that printable adhesive can be pressed through the screen onto the release liner in a desired shape as formed in the negative space of the stencil. In other embodiments, the printable adhesive is dispensed on the release liner via a nozzle controlled by a robotic arm. The nozzle can comprise a needle or jet dispense mechanism that forces drops of printable adhesive through the nozzle using, e.g., a piezoelectric element.

In some embodiments, the shape includes a feature characterized by a transition from a first width at a first point in the path to a second width at a second point in the path. The transition can be sharp, such as a transition characterized by an edge at right angles to the sides of the shape at the two widths, or gradual, such as a curved transition from one width to the other width. In some embodiments, the width of the shape of the printable adhesive is less than one millimeter at all points along the path.

In some embodiments, the printable adhesive is dispensed in a final shape as applied to the surface of the portable electronic device. In other embodiments, the printable adhesive dispensed on the release liner in the shape is subsequently cut to a second shape via a die cutting process to form one or more features in the shape. In some embodiments, the printable adhesive is cooled prior to being cut via the die cutting process.

In some embodiments, the release liner comprises a polymer substrate coated with a thin layer of adhesive. In other embodiments, the release liner includes a paper substrate coated with a polymer.

In some embodiments, the printable adhesive is a pressure sensitive adhesive. In other embodiments, the printable adhesive is a one-part adhesive activated by one of heat or ultraviolet radiation.

In some embodiments, a method is disclosed for adhesively bonding at least two components of a portable electronic device. The method includes the steps of providing a release liner, dispensing a printable adhesive onto a surface of the release liner in a shape, and applying the printable adhesive to the surface of the portable electronic device. A width of the printable adhesive varies along a path to conform with one or more features formed in a surface of the portable electronic device. The shape defines a central area on the surface of the release liner characterized by a lack of printable adhesive and completely enclosed by the printable adhesive.

In some embodiments, the shape is characterized by at least one feature having a dimension of less than one millimeter. A width of the shape can be less than one millimeter in at least one location around the perimeter of the shape and, in some embodiments, can be less than one millimeter at all locations around the perimeter of the shape.

In some embodiments, the dispensing of the printable adhesive in the shape is characterized by an accuracy of plus or minus 50 thousands of an inch of a nominal shape on the surface of the release liner. The accuracy can be defined by a mesh size of the screen used in a screen printing process. Alternatively, the accuracy can be defined by droplet size and nozzle shape of a nozzle dispensing process.

In some embodiments, the portable electronic device is a tablet computer. In other embodiments, the portable electronic device is a mobile phone. The surface of the portable electronic device can include a ledge formed in a cavity of a housing for the portable electronic device. The adhesive can form a seal between the ledge and a mating surface of a display assembly of the portable electronic device.

In some embodiments, a portable electronic device is produced utilizing an adhesive. The portable electronic device includes a housing forming a cavity, a display assembly, and an adhesive dispensed directly onto at least one surface of the housing via a printing process. One or more operational components of the portable electronic device are disposed within the cavity and attached to the housing. The display assembly includes a display and a glass substrate overlaid on a top surface of the display. The adhesive forms a continuous closed path around an opening in the housing that leads to the cavity. The adhesive creates a seal between the display assembly and the housing.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a technique for manufacturing an adhesive to be applied to a surface of a portable electronic device, in accordance with the prior art.

FIG. 2 illustrates another technique for manufacturing an adhesive to be applied to a surface of a portable electronic device, in accordance with the prior art.

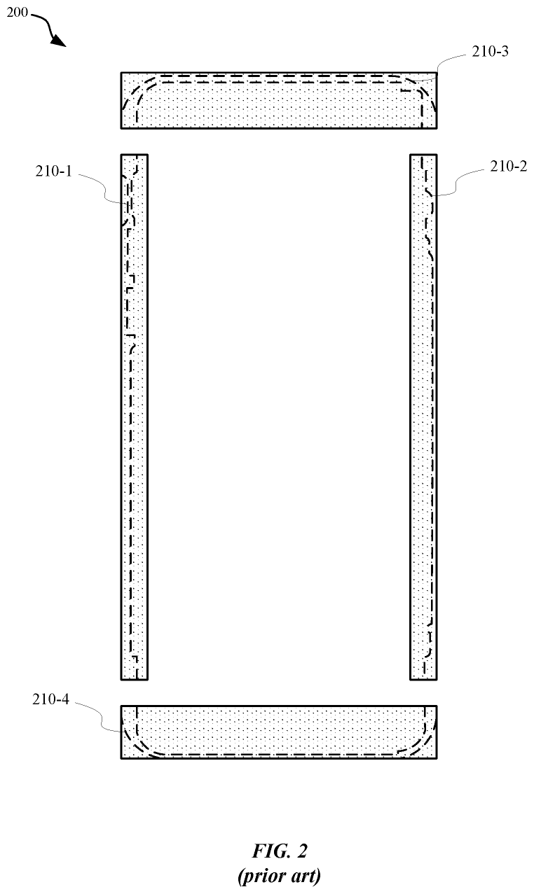

FIG. 3 illustrates a portable electronic device, in accordance with some embodiments.

FIG. 4 depicts a cross section of the portable electronic device, in accordance with some embodiments.

FIG. 5 illustrates a component utilized in the manufacturing of the portable electronic device, in accordance with some embodiments.

FIG. 6 illustrates a component utilized in the manufacturing of the portable electronic device 300, in accordance with some embodiments.

FIG. 7 is a flowchart of a method for applying a ring-shaped printable adhesive to a surface of a portable electronic device, in accordance with some embodiments.

FIG. 8 illustrates a technique for dispensing the printable adhesive directly onto a surface of the portable electronic device, in accordance with some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Ring-shaped adhesives pose particular challenges during the manufacturing of portable electronic devices. Manufacturing the ring-shaped adhesives using traditional methods can result in low efficiency utilization of the raw materials. Manufacturing the ring-shape in sections can reduce the amount of wasted raw materials but lead to difficulties during final assembly with aligning the different sections to re-create the continuous closed path of the ring shape. In cases where the multiple sections of the adhesive are used to create a water-resistant seal, gaps between sections due to misalignment can lead to water incursion into the portable electronic device. These issues can be addressed with different manufacturing techniques.

A printable adhesive can be dispensed onto a release liner using a process that enables the raw material of the adhesive to be dispensed in a desired shape as applied to the bonded surface in order to reduce an amount of wasted adhesive raw material. The accuracy of the printing process can be greater than the accuracy of a conventional die cutting process utilized to cut out a shape from a roll or sheet of pressure sensitive adhesive dispensed over a full release liner, which enables more intricate shapes with smaller features to be dispensed directly onto the release liner than could be achieved with die cutting alone. For example, die cutting can have difficulty producing a final shape having features with a width of less than a millimeter, whereas features produced with a screen printing process can have an accuracy commensurate with a mesh count of the screen.

In some embodiments, the printable adhesive can be dispensed directly onto a surface of the portable electronic device. Screen printing or nozzle dispensing techniques can be utilized to dispense the printable adhesive directly onto the surface of the portable electronic device in a desired shape. The shape can have a small form factor that corresponds to a ledge or other features formed in a housing of the portable electronic device. Dimensions of the shape, including a width of the printable adhesive at a particular location around a path characterized by a continuous closed curve that forms a ring, can be less than a millimeter and have an accuracy of plus or minus 50 micrometers.

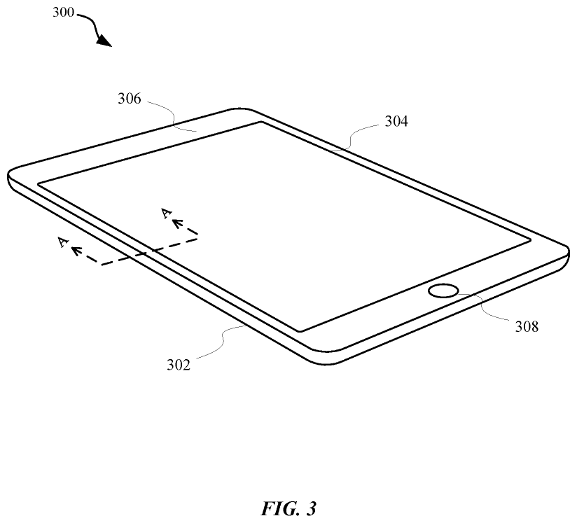

These and other embodiments are discussed below with reference to FIGS. 3-8; however, those skilled in the art will readily appreciate that the detailed description given herein with respect to these figures is for explanatory purposes only and should not be construed as limiting.

FIG. 3 illustrates a portable electronic device 300, in accordance with some embodiments. As depicted in FIG. 3, the portable electronic device 300 is a tablet computer. However, it will be appreciated that the portable electronic device 300 can take other forms such as a mobile phone (e.g., smart phone, cellular phone, etc.), a laptop computer, a personal digital assistant (PDA), a portable music player (e.g., MP3 player), a digital camera, a portable gaming system, a remote control, and the like.

As depicted in FIG. 3, the portable electronic device 300 includes a housing 302 and a display assembly 304. The housing 302 can be formed from aluminum and includes a cavity therein that contains one or more operational components (e.g., processors, memory, printed circuit boards, battery, integrated circuits, passive electronic components, audio transducers, image sensors, etc.). The display assembly 304 can include a liquid crystal display (LCD), organic light emitting diode (OLED) display, and the like. The display assembly 304 is capable of presenting graphics data (e.g., pixel data, images, text, etc.) to a user of the portable electronic device 300. In some embodiments, the display assembly 304 includes a bracket attached to the display. The display assembly 304 can also include a glass substrate 306 that overlays the display and bracket. The glass substrate 306 can also include an opening, where an interface element 308 such as a button or touch-sensitive surface is disposed therein.

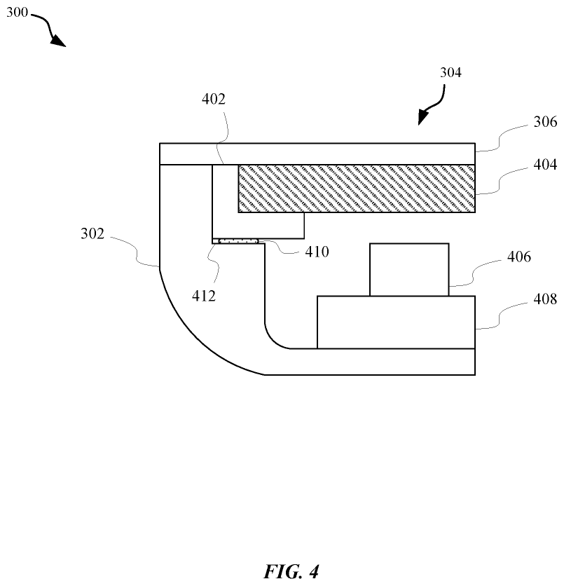

FIG. 4 depicts a cross section of the portable electronic device 300, in accordance with some embodiments. The cross section corresponds to section line A-A in FIG. 3 and depicts an adhesive joint between the housing 302 and the display assembly 304. As depicted in FIG. 4, the display assembly 304 includes a display unit 404 disposed within a bracket 402. The bracket 402 can be a sheet metal bracket or other structural member formed from a structural material such as metal or plastic. The display unit 404 can be, e.g., the LCD and an LED backlight as well as one or more touch sensors for detecting a touch input on a surface of the glass substrate 306 overlaid on a top surface of the display unit 404.

The housing 302 includes a cavity formed therein. Operational components are disposed in the cavity and can be attached to a surface of the housing 302. As depicted in FIG. 4, a circuit component 406 (e.g., integrated circuit package, capacitor, resistor, etc.) is coupled to a printed circuit board 408, which is attached to a bottom surface of the cavity within the housing 302. The housing 302 can also include a ledge 412 formed within the cavity. The ledge 412 can include one or more surfaces formed proximate an edge of the housing 302 that defines an opening through an exterior surface of the housing 302 into the cavity. An adhesive 410 can be applied to the one or more surfaces of the ledge 412.

In some embodiments, the portable electronic device 300 can have a small form factor such that the portable electronic device 300 can be hand-held. In such embodiments, there may be many operational components disposed within the cavity of the housing 302, such that the ledge 412 can be relatively small in order to avoid interfering with any of the operational components. For example, the ledge 412 can have a width of less than, e.g., a few millimeters. In some cases, the ledge 412 can have a width that is within the range of 0.7 millimeters to 1.3 millimeters. The width of the ledge 412 can also vary around the perimeter of the housing 302 of the portable electronic device 300. For example, in some areas, the ledge 412 may be less than one millimeter in width to accommodate other components of the portable electronic device 300. Manufacturing an adhesive part that conforms to a ring shape that matches the surface or surfaces of the ledge 412 can be difficult when trying to maintain tight dimensional tolerances of the adhesive (e.g., plus or minus 50 micrometers) while including features of less than a millimeter in width at various locations.

In some embodiments, the display assembly 304 is attached, via the adhesive 410, to the housing 302. A rear surface of the bracket 402 is bonded to the adhesive 410 such that the rear surface of the bracket 402 opposes the mating surface of the ledge 412. It will be appreciated, however, that the mating surfaces can be designed at different locations or between different components of the portable electronic device 300. For example, the adhesive 410 can be placed between a rear surface of the glass substrate 306 and a top surface of the housing 302. Alternatively, the location of the ledge 412 can be different relative to the top or bottom surface of the housing 302. Furthermore, the display assembly 304 could be adhesively coupled to a separate component that is attached to the housing 302, via separate adhesive or mechanical fasteners.

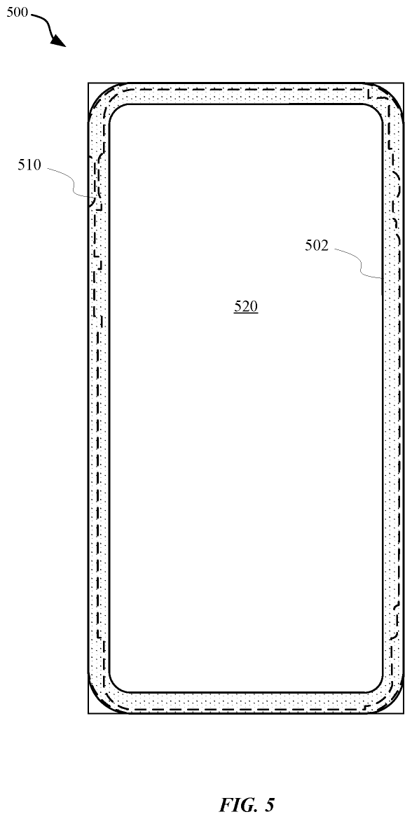

FIG. 5 illustrates a component 500 utilized in the manufacturing of the portable electronic device 300, in accordance with some embodiments. The component 500, which can also be referred to as a part, can include a printable adhesive 502 dispensed onto a release liner 520. The printable adhesive 502 is dispensed in a ring shape. As used herein, a ring shape refers to a continuous closed curve having no intersection, where the width of the ring shape can vary along the curve. The ring shape can be circular, elliptical, or rectangular. The ring shape can also be irregular such as having multiple inflection points along one or more sides. The important characteristic of the ring shape is that the printable adhesive 502 is not dispensed within an interior portion of the ring shape. In other words, the printable adhesive 502 is not dispensed in a central area of the release liner 520 enclosed by the printable adhesive 502.

In some embodiments, the printable adhesive 502 is a pressure sensitive adhesive (PSA) that is semi-solid (e.g., a gel) such that the printable adhesive 502 sticks to a surface of the release liner 520 and remains relatively stable in the dispensed shape. It will be appreciated that the printable adhesive 502 is formulated to be dispensable through, e.g., a screen printing process or through a dispensing jet or needle, which can be referred to generally as nozzle dispensing. In some embodiments, the printable adhesive 502 is dispensed in a liquid state. The liquid adhesive can have sufficient viscosity to prevent the adhesive from flowing away from the dispensed shape while not being so viscous that the liquid adhesive cannot flow through the dispensing equipment (e.g., the screen or nozzle).

In some embodiments, the printable adhesive 502 comprises a one-part adhesive. The printable adhesive 502 can be formulated to be dispensed in a first state and then subsequently activated using, e.g., heat, UV light, a chemical catalyst, or some other method of activation. In other embodiments, the printable adhesive 502 could be, e.g., a two part adhesive.

In some embodiments, the release liner 520 is a coated paper product. A base substrate of paper is coated on one or both sides, typically with a polymer or silicone based material. The coating layer aids in the release of the printable adhesive 502 from the release liner 520. In some embodiments, the release liner 520 can have additional layers or coatings. For example, the coating layer can be further coated with a second material, such as a thin layer of adhesive or chemical designed to change the tackiness or surface characteristics of the release liner 520. In other embodiments, the base substrate of the release liner 520 can be a material other than paper. For example, the release liner 520 can be formed from a polymer. Sheets of polymer can be formed to a desired thickness, such as rolling under applied heat and pressure, and then die cut to a desired shape.

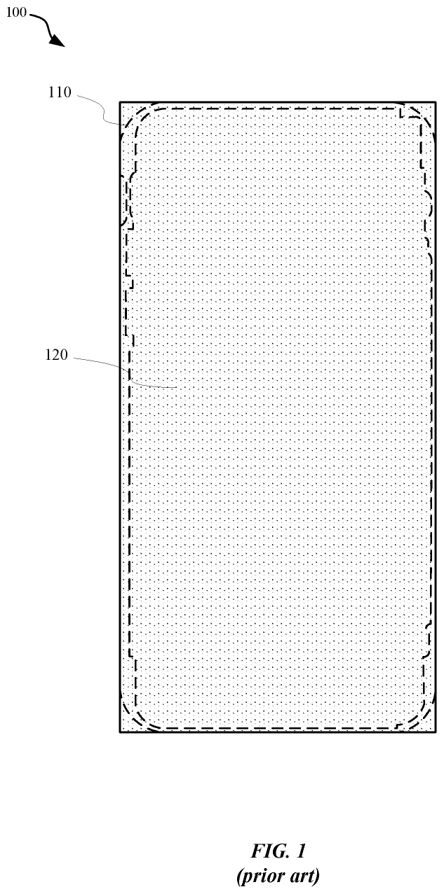

In some embodiments, the printable adhesive 502 is dispensed on a flat rectangular section of the release liner 520 that bounds the extents of the ring shape. Subsequently, the shape 510 can be cut from the dispensed portion of adhesive 502 using, e.g., a die cut machine or other process. It will be appreciated that while the waste of the release liner remains the same as the technique highlighted in FIG. 1, the amount of wasted adhesive is significantly reduced.

In other embodiments, the release liner 520 can be shaped similar to the dispensed shape of the printable adhesive 502. In other words, the release liner 520 can have a shape conforming to a ring shape (e.g., a closed curve of circular, elliptical, or rectangular geometry). Thus, the amount of the release liner 520 that is discarded as waste in subsequent die cut or adhesive application steps can be reduced. However, it will be appreciated that such shapes are difficult to manufacture as a release liner material. For example, paper is produced in rolls or cut into flat sheets, not formed into the ring shapes discussed above. Thus, the ring shape will likely be cut from a roll or rectangular sheet, thereby creating similar wasted paper in an earlier manufacturing process. However, the paper waste at the earlier step may be easier to recycle and re-use in a manner that is environmentally friendly compared to recycling the release liner in a later step where the paper has been treated with coatings or chemicals and adhesive has been dispensed on the release liner. Furthermore, if the paper substrate is cut into a shape prior to coatings being applied to the paper substrate, then the manufacturing of the release liner material can reduce the amount of coating raw material used to manufacture the ring-shaped release liners. Furthermore, in some embodiments, the release liner may not include a paper based product and, therefore, there may be some materials that can be formed or manufactured directly into a ring-shaped release liner. For example, a polymer product could potentially be formed via a molding process directly into a ring shape onto which coatings are applied and adhesive is then dispensed. Such processes may further reduce waste by minimizing the amount of material used for the release liner.

It will be appreciated in FIG. 5 that the amount of dispensed printable adhesive 502 is greater than the amount of printable adhesive 502 that is applied to the surface of the portable electronic device 300 in the shape 510. By dispensing additional printable adhesive 502 onto the release liner 520, the precision of features of the shape 510 is controlled by the subsequent die cut process rather than the precision of the screen printing or dispensing process. Again, in some embodiments, the printable adhesive 502 is going to be applied to surfaces in a portable electronic device 300. The dimensions of such surfaces can be relatively small. For example, a width of the ledge 412 can range from less than one millimeter to a few millimeters. Furthermore, the surface can include features that have dimensions that are within a range of a few mils to tens of mils. For example, the width of the shape 510 can vary around the perimeter of the ring shape, changing in width from, e.g., 50 mils to 30 mils to conform to features in the surface. Those transitions can include instant changes accompanied by sharp corners or gradual changes associated with curved transitions between the two widths. The features in the surface can be designed to accommodate components included in the portable electronic device such as electrical components, flexible cables, antennas, brackets, fasteners, and the like.

A precision of a screen printing process can be limited by a size of cells in the screen. As used herein, a cell refers to the negative space between interwoven fibers or threads in the mesh of the screen through which the printable adhesive 502 can flow while being applied to the release liner 520. The spacing and size of the cells dictates the precision of the features in the printable adhesive 502 that can be dispensed onto the release liner 520. Typical cell sizes can vary between approximately one mil to tens of mils. While smaller cell size can increase the precision of the screen printing process, viscous fluids can be more difficult to press through the smaller cells. The viscosity and chemistry of the printable adhesive 502 can limit the minimum cell size that can be utilized using the screen printing process, thereby limiting the precision of the printed shape 510 achieved with the screen printing process.

In some embodiments, the die cutting process can create more precise features in the dispensed printable adhesive 502 than compared to the precision of features achievable using the screen printing process alone. In other embodiments, the screen printing process is more precise than the die cutting process. For example, features formed via the shear mechanism of the die may be less precise because the printable adhesive 502 sticks to the die or deforms while being cut. The die cutting process can be especially problematic where features are extremely small (e.g., less than one millimeter in width). In such embodiments, the dispensing step can be adjusted to dispense the printable adhesive 502 onto the release liner 520 in the final shape 510, omitting the subsequent die cutting process.

Similarly, other dispensing techniques, such as dispensing printable adhesive through a nozzle, jet, or needle may be less precise or more precise than the die cutting process. In the case where the dispensing technique is less precise than the die cutting process, then the printable adhesive 502 can be dispensed in a first shape that includes margins that are greater than the final shape 510 that is formed during the die cutting process. In the case where the dispensing technique is more precise than the die cutting process, then the printable adhesive 502 can be dispensed in the final shape 510 and the die cutting process can be omitted.

In some embodiments, the die cutting process can be more effective if combined with a cooling process. Prior to placing the printable adhesive 502 into the die cut machine, the printable adhesive 502 on the release liner 520 can be cooled to lower the temperature of the printable adhesive 502 and make the printable adhesive more brittle and/or less tacky. These properties can improve the results of the die cut process.

In some embodiments, the dispensing technique can be utilized to dispense adhesive in varying thicknesses at different points within the shape. For example, multiple layers of the adhesive can be built up by applying multiple layers of the adhesive using different screens in succession. Alternatively, the nozzle dispensing process can be performed over multiple passes building up multiple layers of adhesive in particular locations over multiple passes. This can be useful when the geometry of a mating component is not uniform or flat such that a distance between the surface on a first component (e.g., the housing) and a surface on a second component (e.g., the display assembly bracket) is not uniform at all locations of the surface when the components are bonded.

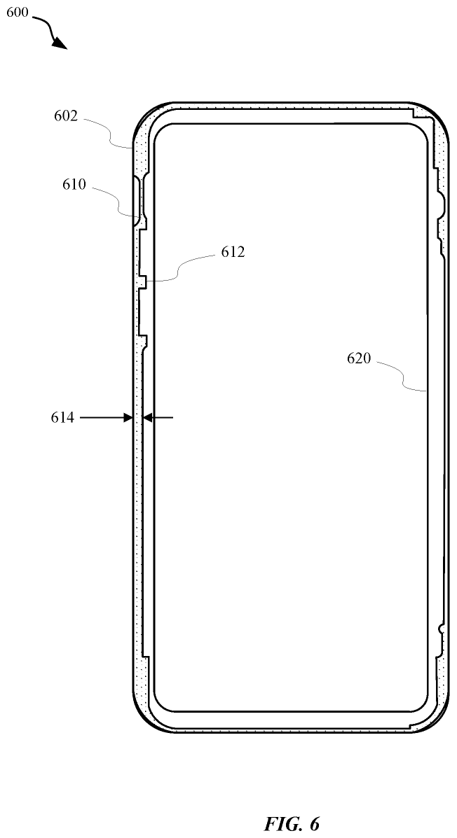

FIG. 6 illustrates a component 600 utilized in the manufacturing of the portable electronic device 300, in accordance with some embodiments. The component 600 is similar to the component 500 except that the printable adhesive 602 is dispensed onto the release liner 620 in a shape 610 that conforms with the one or more surfaces of the portable electronic device 300 to which the printable adhesive 602 will be applied.

It will be appreciated that the die cutting step can be omitted as the die cutting step is not required to form the ring shape 610 in the printable adhesive 602. Furthermore, it will be appreciated that the release liner 620 is shown as also having a general ring shape, although the ring shape of the release liner 620 can have a uniform width along the perimeter of the ring shape. The release liner 620 can be manufactured prior to dispensing the printable adhesive 602 thereon to remove a central portion of the release liner 620. Alternatively, the release liner 620 could be manufactured in the ring shape initially (e.g., through a molding process, extrusion and slicing process, or the like). It will be appreciated that, in other embodiments, the release liner 620 is a rectangular shape that bounds the extents of the ring shape 610 and includes material that fills the interior space of the ring shape 610, similar to release liner 520 shown in FIG. 5. However, even in these embodiments, the printable adhesive 602 is dispensed on the release liner 620 in the shape 610 to be applied to the one or more surfaces of the portable electronic device 300.

The shape 610 of the printable adhesive 602 follows a path characterized by a continuous closed curve that forms a ring. The shape 610 also completely encloses an area on the release liner 620 without printable adhesive dispensed therein, and has a width that varies along the path. The shape can include features, such as feature 612, characterized by a transition from a first width at a first point in the path to a second width at a second point in the path. Notably, a width 614 of the shape refers to a distance across the printable adhesive 602 in a direction perpendicular to the path at a particular location of the path.

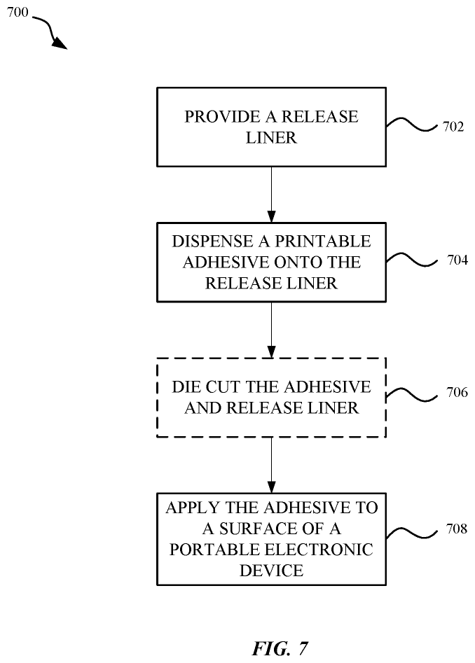

FIG. 7 is a flowchart of a method 700 for applying a ring-shaped printable adhesive to a surface of a portable electronic device, in accordance with some embodiments. At step 702, a release liner is provided. The release liner can be rectangular having a size and shape that conforms to the extents of one or more surfaces of the portable electronic device. In other embodiments, the release liner can have a shape that conforms, generally, with the shape of one or more surfaces of the portable electronic device.

At 704, a printable adhesive is dispensed onto a surface of the release liner in a shape. The shape defines a central area on the surface of the release liner characterized by a lack of dispensed printable adhesive within the central area. In some embodiments, a width of the printable adhesive along the path is significantly less than a width of the central area. For example, the shape can have a distance between two edges of the printable adhesive across the central area can be 50 to 70 millimeters, which corresponds to a distance between surfaces of a ledge formed around an opening in the housing of the portable electronic device, whereas a width of the printable adhesive can be less than a few millimeters. In some embodiments, the width of the printable adhesive varies along a path to conform with one or more features formed in a surface of the portable electronic device.

At 706, optionally, the adhesive and release liner can be cut via a die cutting machine. The die cutting process can change the shape of the adhesive into a desired shape as applied to a surface of the portable electronic device. The desired shape can still be generally ring shaped, but can include at least one feature such as a transition between a first width and a second width in the dispensed printable adhesive. The feature(s) can be small, such as features characterized by a dimension in the few to tens of thousands of an inch. In some embodiments, the die cutting step is preceded by a cooling step where the adhesive on the release liner is cooled to a desired temperature prior to being die cut. The cooling step can increase the brittleness and/or reduce the tackiness of the adhesive and improve the accuracy of the cut edges of the printable adhesive that result from the die cutting process.

At 708, the printable adhesive is applied to a surface of the portable electronic device. In some embodiments, the printable adhesive can be applied by applying pressure to the rear surface of the release liner while the printable adhesive is contacting the surface of the portable electronic device and then removing the release liner thereby leaving the printable adhesive on the surface of the portable electronic device. In some embodiments, the printable adhesive is applied manually. In other embodiments, the printable adhesive is applied automatically by an application robot or other automated assembly means.

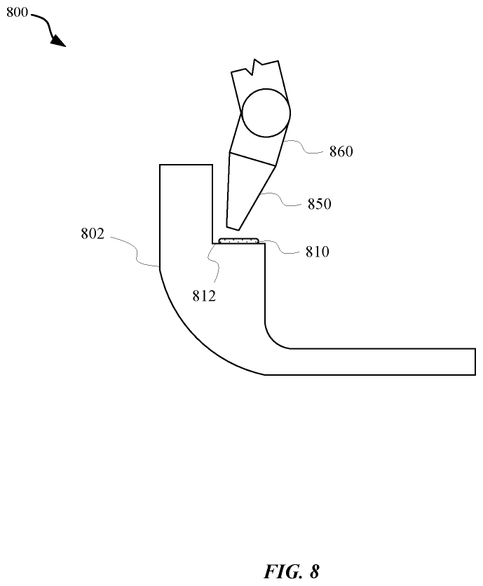

FIG. 8 illustrates a technique for dispensing the printable adhesive directly onto a surface of the portable electronic device 800, in accordance with some embodiments. In some cases, the surface of the portable electronic device 800 is conducive to directly printing the adhesive onto the surface as opposed to a release liner. For example, if the surface is a flat surface on top of the housing 302, then the adhesive 412 could be directly dispensed onto the surface of the portable electronic device 300 via a screen printing process. Alternatively, in the case where the surface is recessed below the top surface of the housing 302, a robotically controlled nozzle could be utilized to dispense the adhesive directly onto the surface.

As depicted in FIG. 8, a nozzle 850 connected to a robotic arm 860 can be controlled to move along a path that defines the shape of the printable adhesive 810 as dispensed on a surface 812 of a housing 802 of the portable electronic device 800. The shape can also include at least one feature, such as a transition between different widths of the ring shape along different points on a closed path corresponding to the shape. The nozzle can be moved along the path and printable adhesive 810 can be dispensed therefrom. The robotic arm 860 controls the position of the nozzle and an element of the nozzle is activated to dispense a droplet of printable adhesive 810 at that position. The nozzle can be moved around a path to deposit droplets in a shape of the printable adhesive 810 as dispensed on the surface 812 of the housing 802.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A component utilized in the manufacture of a portable electronic device, the component comprising:
a release liner; and
a printable adhesive dispensed on the release liner in a shape that conforms with a surface of the portable electronic device,
wherein the shape of the printable adhesive:
follows a path characterized by a continuous closed curve,
encloses an area on the release liner without printable adhesive dispensed therein, and
having a width that varies along the path.

2. The component of claim 1, wherein the printable adhesive is dispensed on the release liner using a screen printing process.

3. The component of claim 1, wherein the printable adhesive is dispensed on the release liner via a nozzle controlled by a robotic arm.

4. The component of claim 1, wherein the shape includes a feature characterized by a transition from a first width at a first point in the path to a second width at a second point in the path.

5. The component of claim 1, wherein the width of the shape of the printable adhesive is less than one millimeter at all points along the path.

6. The component of claim 1, wherein the printable adhesive dispensed on the release liner in the shape is subsequently cut to a second shape via a die cutting process to form one or more features in the shape.

7. The component of claim 6, wherein the printable adhesive is cooled prior to being cut via the die cutting process.

8. The component of claim 1, wherein the release liner comprises a polymer substrate coated with a thin layer of adhesive.

9. The component of claim 1, wherein the release liner comprises a paper substrate coated with a polymer.

10. The component of claim 1, wherein the printable adhesive is a pressure sensitive adhesive.

11. A method for adhesively bonding at least two components of a portable electronic device, the method comprising:
providing a release liner;
dispensing a printable adhesive onto a surface of the release liner in a shape, wherein:
a width of the printable adhesive varies along a path to conform with one or more features formed in a surface of the portable electronic device, and
the shape defines a central area on the surface of the release liner characterized by a lack of printable adhesive and completely enclosed by the printable adhesive; and
applying the printable adhesive to the surface of the portable electronic device.

12. The method of claim 11, wherein the shape is characterized by at least one feature having a dimension of less than one millimeter.

13. The method of claim 12, wherein the dispensing of the printable adhesive in the shape is characterized by an accuracy of plus or minus 50 thousands of an inch of a nominal shape on the surface of the release liner.

14. The method of claim 11, wherein the portable electronic device comprises a tablet computer.

15. The method of claim 11, wherein the surface of the portable electronic device comprises a ledge formed in a cavity of a housing for the portable electronic device.

16. The method of claim 11, wherein the dispensing comprises one of:
dispensing the printable adhesive through a screen onto the surface of the release liner, or
dispensing the printable adhesive through a nozzle onto the surface of the release liner.

17. A portable electronic device including components bonded via printable adhesive, the portable electronic device comprising:
a housing comprising an inner cavity, wherein one or more operational components of the portable electronic device are disposed within the cavity and attached to the housing;
a display assembly comprising a display and a glass substrate overlaid on a top surface of the display; and
an adhesive dispensed directly onto at least one surface of the housing via a printing process, the adhesive forming a continuous closed path around an opening in the housing that leads to the cavity.

18. The portable electronic device of claim 17, wherein the printing process comprises a screen printing process.

19. The portable electronic device of claim 17, wherein the printing process comprises dispensing the adhesive via a nozzle controlled by a robotic arm.

20. The portable electronic device of claim 17, wherein the portable electronic device comprises a tablet computer.
